(19) United States
(12) Patent Application Publication
(10) Pub. No.: US 2012/0107840 A1
(43) Pub. Date: May 3, 2012

(54) Methods for Label Free Testing of Cells

(75) Inventors: Richard W. Wagner, Cambridge, MA (US); Kaan Certel, Cambridge, MA (US); Steven Shamah, Acton, MA (US); Alexander Yuzhakov, West Roxbury, MA (US); Lance G. Laing, Belmont, MA (US)

(73) Assignee: SRU Biosystems, Inc, Woburn, MA (US)

(21) Appl. No.: 13/291,741

(22) Filed: Nov. 8, 2011

Related U.S. Application Data
(63) Continuation-in-part of application No. 12/421,294, filed on Apr. 9, 2009.
Application No. 12/421,294 is a continuation-in-part of application No. 13/240,406, filed on Sep. 22, 2011.
(60) Provisional application No. 61/043,478, filed on Apr. 9, 2008.

(51) Int. Cl. G01N 21/84

(52) U.S. Cl. 435/7.24; 435/7.21

(57) ABSTRACT

The invention provides methods of detecting activation of an immune cell, methods for detecting blocking or enhancing properties of a test reagent or stimuli on activation of one or more immune cells or platelets, methods for selecting hybridomas producing antibodies to an antigen for quality of strength of binding to the antigen, methods for determining if a subject has had an immune response to an immunogen, methods of isolating neutralizing antibodies for an immunogen, methods of classifying a B cell lymphoma, and methods for selecting activated B-cells expressing an antibody to one or more antigens.

### PRIORITY

This application is a continuation-in-part of U.S. Ser. No. 12/421,294, filed Apr. 9, 2009, and is a continuation-in-part of U.S. Ser. No. 13/240,406, filed Sep. 22, 2011, both of which claim the benefit of U.S. Ser. No. 61/043,478, filed on Apr. 9, 2008, all of which are incorporated herein by reference in their entirety.

### BACKGROUND OF THE INVENTION

It has been estimated that at least two days of laboratory time and the use of fluorescent labels are required to assess cellular changes upon exposure to biological entities. See, e.g., Dharmawardhane et al., 1997, J. Cell Biol. 138(6):1265-78. Additionally, it has been estimated that at least 8-24 hours of laboratory time and the use of a secondary dye are required to quantify total cell movement or cell changes toward biological entities, such as a protein, peptide or small molecule. See, Reckless & Grainger. 1999. Biochem. J. 340: 803-811, Taguchi et al. 1998. J. Exp. Med. 187(12): 1927-1940, Jackson et al. 1999. J. Pharm. & Exper. Therapeutics. 288(1): 286-294 and Yarrow et al., 2004 BMC Biotechnol. 4(21):1-9. Methods are needed to reduce the time to perform these assays.

### SUMMARY OF THE INVENTION

One embodiment of the invention provides a method for detecting activation of immune cells or platelets. The method comprises immobilizing one or more adhesion proteins or extracellular matrix molecules on the surface of a colorimetric resonance reflectance biosensor; adding one or more types of immune cells or platelets to the surface of the biosensor; adding a potential activator of the immune cells or the platelets to the surface of the biosensor; detecting adhesion of the immune cells to the adhesion proteins or the adhesion of the platelets to the extracellular matrix molecules on the surface of the biosensor by illuminating the biosensor and detecting changes in peak wavelength values over time. An increase in peak wavelength values over time indicates that the potential activator of the immune cells has activated the immune cells or that the potential activator of the platelets has activated the platelets. The immune cells can be lymphocytes or granulocytes. The adhesion protein can be ICAM-1 or VCAM-1.

Another embodiment of the invention provides a method for detecting blocking or enhancing properties of a test reagent or stimuli on activation of one or more immune cells or platelets. The method comprises immobilizing one or more adhesion proteins or extracellular matrix molecules on the surface of a colorimetric resonance reflectance biosensor; adding one or more types of immune cells or platelets to the surface of the biosensor; adding an activator of the immune cells or platelets to the surface of the biosensor; adding a test reagent or stimuli to the surface of the biosensor; wherein the one or more types of immune cells, platelets, activator, and test reagent or stimuli can be added to the biosensor surface sequentially in any order, or at the same time. Adhesion of the immune cells to the adhesion proteins or adhesion of the platelets to the extracellular matrix molecules is detected on the surface of the biosensor by illuminating the biosensor and detecting changes in peak wavelength values over time for each immune cell or platelet. The changes in peak wavelength values are compared for each immune cell or platelet to a control that does not comprise the test reagent or stimuli, wherein an increase in peak wavelength values over time indicates that the test reagent or stimuli enhances immune cell or platelet activation, and wherein a decrease in peak wavelength values over time indicates that the test reagent or stimuli blocks activation of the immune cells. The adhesion protein can be ICAM-1 or VCAM-1.

Still another embodiment of the invention provides a method of selecting hybridomas producing antibodies to an antigen for highest strength of binding to the antigen. The method comprises adding one or more hybridomas to the surface of colorimetric resonance reflectance biosensor having one or more integrin ligands immobilized to the biosensor surface; adding the antigen to which the hybridomas are specific to the surface of the biosensor; illuminating the biosensor and detecting changes in peak wavelength value over time for each hybridoma; and selecting and isolating the hybridomas with the largest increases in peak wavelength value over time. The hybridomas that are selected produce antibodies to the antigen with the highest strength of binding to the antigen. The method can further comprise adding the individual selected hybridomas to a colorimetric resonant reflectance biosensor, wherein capture molecules for the antibodies produced by the hybridoma are immobilized on the biosensor surface and allowing the hybridoma to multiply to form a hybridoma population; illuminating the biosensor and detecting changes in peak wavelength value for each hybridoma; selecting hybridomas having the greatest increase in peak wavelength value. The selected hybridomas produce the greatest quantity of antibodies. The one or more integrin ligands can be VCAM-1 or ICAM-1.

Yet another embodiment of the invention provides a method of determining if a subject has had an immune response to an immunogen. The method comprises obtaining test B cells from a subject; adding the test B cells to the surface of a colorimetric resonance reflectance biosensor having one or more integrin ligands immobilized to the biosensor surface; adding the immunogen to the surface of the biosensor; illuminating the biosensor and detecting changes in peak wavelength values over time for the test B cells. The changes in peak wavelength values for the test B cells are compared to a control B cell population that does not react with the immunogen. An increase in peak wavelength values over time for the test B cells as compared to the control B cells indicates that the subject has had an immune response to the immunogen. The one or more integrin ligands can be VCAM-1 or ICAM-1.

Another embodiment of the invention provides a method of isolating neutralizing antibodies for an immunogen. The method comprises obtaining test B cells from a subject that has had an immune response to the immunogen; adding the test B cells to the surface of a colorimetric resonance reflectance biosensor having one or more integrin ligands immobilized to the biosensor surface; adding the immunogen to the surface of the biosensor; illuminating the biosensor and detecting changes in peak wavelength values over time for each test B cell; comparing the changes in peak wavelength values for each test B cell to a control B cell that does not react with the immunogen or is not exposed to the immunogen; isolating the test B cells having peak wavelength values higher than the control B cell; and isolating antibodies produced by the isolated test B cells. Neutralizing antibodies for the immunogen are thereby isolated. The one or more integrin ligands are VCAM-1 or ICAM-1.

Yet another embodiment of the invention provides a method of classifying a B cell lymphoma. The method comprises obtaining a B cell sample from a patient with an unclassified B cell lymphoma; adding the B cell sample to the surface of a colorimetric resonance reflectance biosensor having one or more adhesion proteins immobilized to the biosensor surface; adding one or more chemokines to the biosensor; optionally adding one or more specific inhibitors of GTPases to the biosensor; illuminating the biosensor and detecting changes in peak wavelength values over time for each B cell sample; and comparing the responses of the B cell samples to known responses of B cell samples from patients with classified B cell lymphoma such that the B cell lymphoma is classified. The one or more adhesion proteins can be VCAM-1 or ICAM-1.

Even another embodiment of the invention provides a method for selecting activated B-cells expressing an antibody to one or more antigens. The method comprises adding B-cells expressing antibody libraries on their cell surfaces to the surface of a colorimetric resonance reflectance biosensor having one or more integrin ligands immobilized to the biosensor surface; adding the one or more antigens to the surface of the colorimetric resonance reflectance biosensor; determining the amount of activation of each B-cell on the biosensor surface by illuminating the biosensor and determining the changes in peak wavelength values over time for each B cell, wherein an increase in peak wavelength values over time indicates B cell activation, and wherein a decrease or no change in peak wavelength values over time indicates no B cell activation; and isolating activated B cells. A B-cell that expresses an antibody to the one or more antigens is thereby selected. Polynucleotide sequences corresponding to the expressed antibodies can be amplified. The one or more integrin ligands can be VCAM-1 or ICAM-1.

### BRIEF DESCRIPTION OF THE DRAWINGS

FIG. 1A shows a cross-sectional view of a colorimetric resonant reflectance biosensor wherein light is shown as illuminating the bottom of the biosensor; however, light can illuminate the biosensor from either the top or the bottom. FIG. 1B shows a diagram of a colorimetric resonant reflectance biosensor wherein light is shown as illuminating the bottom of the biosensor; however, light can illuminate the biosensor from either the top or the bottom;

FIG. 2 shows an embodiment of a colorimetric resonant reflection biosensor comprising a one-dimensional grating.

FIG. 3 shows a schematic diagram of a VLA-4 and VCAM-1 adhesion assay.

FIG. 4 shows the results from a VLA-4 and VCAM-1 adhesion assay.

FIG. 5A-D shows detection of B cell adhesion mediated by B cell receptor activation. Panel A shows cell count. Panel B shows cell area. Panel C shows cell fraction (the amount of cells giving a signal). Panel D shows cell adhesion response.

FIG. 6A-B shows detection of B cell adhesion to a VCAM-1 coated biosensor in the presence of test compounds. Panel A shows cell fraction (the amount of cells giving a signal). Panel B shows cell adhesion response.

### DETAILED DESCRIPTION OF THE INVENTION

As used herein, the singular forms “a,” “an”, and “the” include plural referents unless the context clearly dictates otherwise.

One embodiment of the invention allows the direct detection of cell changes as they occur in real time with a colorimetric resonant reflectance biosensor and without the need to incorporate or without interference from radiometric, colorimetric, or fluorescent labels. Changes in cell behavior and morphology can be detected as the cell is perturbed. The cellular changes can then be detected in real time using a high speed, high resolution instrument, such as the BIND® Scanner (i.e., a colorimetric resonant reflectance biosensor system), and corresponding algorithms to quantify data. See, e.g., U.S. Pat. No. 6,951,715 and U.S. Pat. Publ. 2004/0151626. By combining this methodology, instrumentation and computational analysis, cellular behavior can be expediently monitored in real time, in a label free manner.

Colorimetric resonant reflectance biosensors, such as SRU Biosystems, Inc. BIND® technology (Woburn, Mass.) have the capability of measuring changes to a surface with respect to mass attachment from nanoscale biological systems. The applications and the methods, in which colorimetric resonant reflectance biosensors have been previously implemented, have changed as the resolution of the instruments has improved. Previously, measurement of the quantity of cells attached to the colorimetric resonant reflectance biosensor surface was the primary goal. While looking at some poorer resolution images of cells, however, it was noted that cells gave differential signals with respect to the number of pixels occupied, intensity of signal/pixel, change in PWV of each pixel, etc. While trying to reduce the variability of these data, it became clear that the variability lay within the individual cells and their differential morphological responses to stimuli. To further investigate these cellular events, a higher resolution version of a BIND® Scanner (i.e., a colorimetric resonant reflectance biosensor system), was constructed. The scanner has a higher resolution lens than previously used scanners. The lens has a lower limit pixel size of about 3.5 micrometers. Additionally, a methodology was developed for analyzing cell changes in real time at better resolution.

### Biosensors

Biosensors of the invention can be colorimetric resonant reflectance biosensors. See e.g., Cunningham et al., “Colorimetric resonant reflection as a direct biochemical assay technique,” Sensors and Actuators B, Volume 81, p. 316-328, Jan. 5, 2002; U.S. Pat. Publ. No. 2004/0091397. Colorimetric resonant biosensors are not surface plasmon resonant (SPR) biosensors. SPR biosensors have a thin metal layer, such as silver, gold, copper, aluminum, sodium, and indium. The metal must have conduction band electrons capable of resonating with light at a suitable wavelength. A SPR biosensor surface exposed to light must be pure metal. Oxides, sulfides and other films interfere with SPR. Colorimetric resonant biosensors do not have a metal layer, rather they have a dielectric coating of high refractive index material, such as TiO₂.

Grating-based waveguide biosensors are described in, e.g., U.S. Pat. No. 5,738,825. A grating-based waveguide biosensor comprises a waveguiding film and a diffraction grating that incouples an incident light field into the waveguiding film to generate a diffracted light field. A change in the effective refractive index of the waveguiding film is detected. Devices where the wave must be transported a significant distance within the device, such as grating-based waveguide biosensors, lack the spatial resolution of the current invention.

A colorimetric resonant reflectance biosensor allows biochemical interactions to be measured on the biosensor's surface without the use of fluorescent tags, colorimetric labels or any other type of detection tag or detection label. A biosensor surface contains an optical structure that, when illuminated with collimated and/or white light, is designed to reflect only a narrow band of wavelengths (“a resonant grating effect”). The narrow wavelength band (e.g., about 1 to about 10 nm) is described as a wavelength “peak.” The “peak wavelength value” (PWV) changes when materials, such as biological materials, are deposited or removed from the biosensor surface. A readout instrument is used to illuminate distinct locations on a biosensor surface with collimated and/or white light, and to collect reflected light. The collected light is gathered into a wavelength spectrometer for determination of a PWV.

A biosensor can be incorporated into standard disposable laboratory items such as microtiter plates by bonding the structure (biosensor side up) into the bottom of a bottomless microtiter plate cartridge. Incorporation of a biosensor into common laboratory format cartridges is desirable for compatibility with existing microtiter plate handling equipment such as mixers, incubators, and liquid dispensing equipment. Colorimetric resonant reflectance biosensors can also be incorporated into, e.g., microfluidic, macrofluidic, or microarray devices (see, e.g., U.S. Pat. No. 7,033,819, U.S. Pat. No. 7,033,821). Colorimetric resonant reflectance biosensors can be used with well-know methodology in the art (see, e.g., Methods of Molecular Biology edited by Jun-Lin Guan, Vol. 294, Humana Press, Totowa, N.J.) to monitor cell behavioral changes or the lack of these changes upon exposure to one or more extracellular reagents.

Colorimetric resonant reflectance biosensors comprise subwavelength structured surfaces (SWS) and are an unconventional type of diffractive optic that can mimic the effect of thin-film coatings. (Peng & Morris, “Resonant scattering from two-dimensional gratings,” J. Opt. Soc. Am. A, Vol. 13, No. 5, p. 993, May 1996; Magnusson, & Wang, “New principle for optical filters,” Appl. Phys. Lett., 61, No. 9, p. 1022, August, 1992; Peng & Morris, “Experimental demonstration of resonant anomalies in diffraction from two-dimensional gratings,” Optics Letters, Vol. 21, No. 8, p. 549, April, 1996). A SWS structure contains a one-dimensional, two-dimensional, or three dimensional grating in which the grating period is small compared to the wavelength of incident light so that no diffractive orders other than the reflected and transmitted zeroth orders are allowed to propagate. Propagation of guided modes in the lateral direction is not supported. Rather, the guided mode resonant effect occurs over a highly localized region of approximately 3 microns from the point that any photon enters the biosensor structure.

The reflected or transmitted light of a colorimetric resonant reflectance biosensor can be modulated by the addition of molecules such as specific binding substances or binding partners or both to the upper surface of the biosensor. The added molecules increase the optical path length of incident radiation through the structure, and thus modify the wavelength at which maximum reflectance or transmittance will occur.

In one embodiment, a colorimetric resonant reflectance biosensor, when illuminated with white and/or collimated light, is designed to reflect a single wavelength or a narrow band of wavelengths (a “resonant grating effect”). When mass is deposited on the surface of the biosensor, the reflected wavelength is shifted due to the change of the optical path of light that is shown on the biosensor.

A detection system consists of, for example, a light source that illuminates a small spot of a biosensor at normal incidence through, for example, a fiber optic probe, and a spectrometer that collects the reflected light through, for example, a second fiber optic probe also at normal incidence. Because no physical contact occurs between the excitation/detection system and the biosensor surface, no special coupling prisms are required and the biosensor can be easily adapted to any commonly used assay platform including, for example, microtiter plates. A single spectrometer reading can be performed in several milliseconds, thus it is possible to quickly measure a large number of molecular interactions taking place in parallel upon a biosensor surface, and to monitor reaction kinetics in real time.

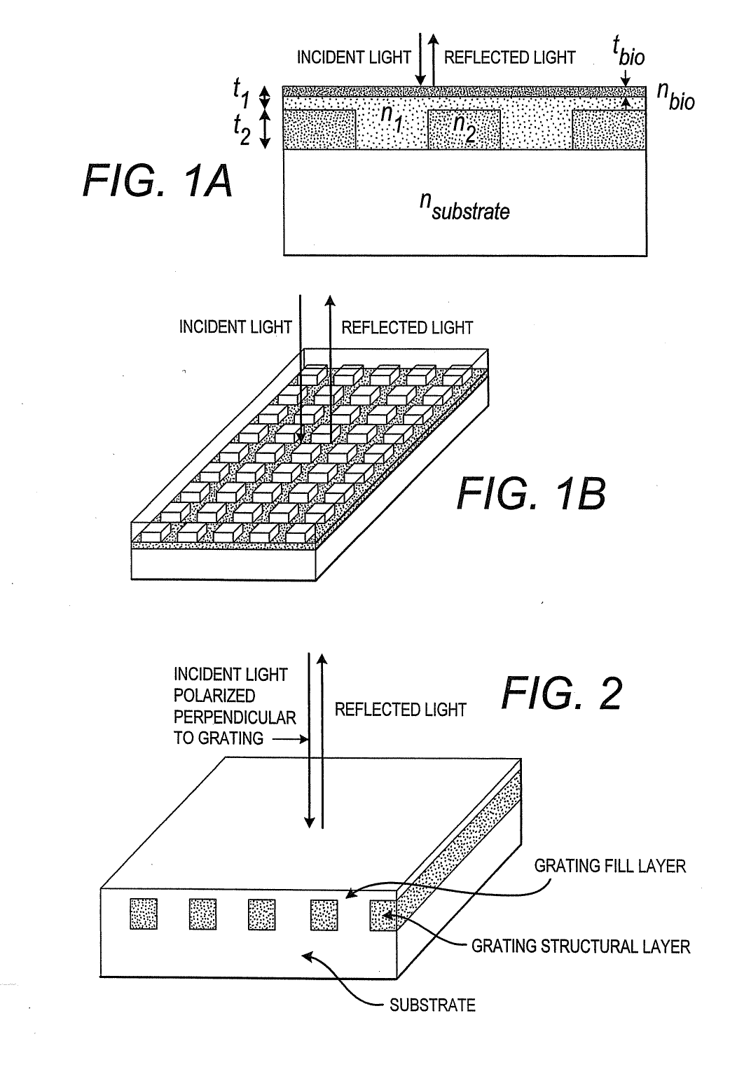

FIGS. 1A and 1B are diagrams of an example of a colorimetric resonant reflectance biosensor. In FIG. 1, n_{substrate} represents a substrate material. n₂ represents the refractive index of an optical grating. n₁ represents an optional cover layer. n_{bio} represents the refractive index of an optional biological material. t₁ represents the thickness of the optional cover layer above the one-, two- or three-dimensional grating structure. t₂ represents the thickness of the grating. t_{bio} represents the thickness of the layer of the biological material. In one embodiment, are n2<n1 (see FIG. 1A). Layer thicknesses (i.e. cover layer, biological material, or an optical grating) are selected to achieve resonant wavelength sensitivity to additional molecules on the top surface. The grating period is selected to achieve resonance at a desired wavelength.

A colorimetric resonant reflectance biosensor comprises, e.g., an optical grating comprised of a high refractive index material, a substrate layer that supports the grating, and optionally one or more specific binding substances or linkers immobilized on the surface of the grating opposite of the substrate layer. The high refractive index material has a higher refractive index than a substrate layer. See, e.g., U.S. Pat. No. 7,094,595; U.S. Pat. No. 7,070,987. Optionally, a cover layer covers the grating surface. An optical grating is coated with a high refractive index dielectric film which can be comprised of a material that includes, for example, zinc sulfide, titanium dioxide, titanium oxide, titanium phosphate, tantalum oxide, silicon nitride, and silicon dioxide. A cross-sectional profile of a grating with optical features can comprise any periodically repeating function, for example, a “square-wave.” An optical grating can also comprise a repeating pattern of shapes selected from the group consisting of lines (one-dimensional), squares, circles, ellipses, triangles, trapezoids, sinusoidal waves, ovals, rectangles, and hexagons. A colorimetric resonant reflectance biosensor of the invention can also comprise an optical grating comprised of, for example, plastic or epoxy, which is coated with a high refractive index material.

Linear gratings (i.e., one dimensional gratings) have resonant characteristics where the illuminating light polarization is oriented perpendicular to the grating period. A schematic diagram of one embodiment a linear grating structure with an optional cover layer is shown in FIG. 2. A colorimetric resonant reflection biosensor can also comprise, for example, a two-dimensional grating, e.g., a hexagonal array of holes or squares. Other shapes can be used as well. A linear grating has the same pitch (i.e. distance between regions of high and low refractive index), period, layer thicknesses, and material properties as a hexagonal array grating. However, light must be polarized perpendicular to the grating lines in order to be resonantly coupled into the optical structure. Therefore, a polarizing filter oriented with its polarization axis perpendicular to the linear grating must be inserted between the illumination source and the biosensor surface. Because only a small portion of the illuminating light source is correctly polarized, a longer integration time is required to collect an equivalent amount of resonantly reflected light compared to a hexagonal grating.

An optical grating can also comprise, for example, a “stepped” profile, in which high refractive index regions of a single, fixed height are embedded within a lower refractive index cover layer. The alternating regions of high and low refractive index provide an optical waveguide parallel to the top surface of the biosensor.

A colorimetric resonant reflectance biosensor of the invention can further comprise a cover layer on the surface of an optical grating opposite of a substrate layer. Where a cover layer is present, the one or more specific binding substances are immobilized on the surface of the cover layer opposite of the grating. Preferably, a cover layer comprises a material that has a lower refractive index than a material that comprises the grating. A cover layer can be comprised of, for example, glass (including spin-on glass (SOG)), epoxy, or plastic.

For example, various polymers that meet the refractive index requirement of a biosensor can be used for a cover layer. SOG can be used due to its favorable refractive index, ease of handling, and readiness of being activated with specific binding substances using the wealth of glass surface activation techniques. When the flatness of the biosensor surface is not an issue for a particular system setup, a grating structure of SiN/glass can directly be used as the sensing surface, the activation of which can be done using the same means as on a glass surface.

Resonant reflection can also be obtained without a planarizing cover layer over an optical grating. For example, a biosensor can contain only a substrate coated with a structured thin film layer of high refractive index material. Without the use of a planarizing cover layer, the surrounding medium (such as air or water) fills the grating. Therefore, specific binding substances are immobilized to the biosensor on all surfaces of an optical grating exposed to the specific binding substances, rather than only on an upper surface.

In general, a colorimetric resonant reflectance biosensor of the invention will be illuminated with white and/or collimated light that will contain light of every polarization angle. The orientation of the polarization angle with respect to repeating features in a biosensor grating will determine the resonance wavelength. For example, a “linear grating” (i.e., a one-dimensional grating) biosensor consisting of a set of repeating lines and spaces will have two optical polarizations that can generate separate resonant reflections. Light that is polarized perpendicularly to the lines is called “s-polarized,” while light that is polarized parallel to the lines is called “p-polarized.” Both the s and p components of incident light exist simultaneously in an unfiltered illumination beam, and each generates a separate resonant signal. A biosensor can generally be designed to optimize the properties of only one polarization (the s-polarization), and the non-optimized polarization is easily removed by a polarizing filter.

In order to remove the polarization dependence, so that every polarization angle generates the same resonant reflection spectra, an alternate biosensor structure can be used that consists of a set of concentric rings. In this structure, the difference between the inside diameter and the outside diameter of each concentric ring is equal to about one-half of a grating period. Each successive ring has an inside diameter that is about one grating period greater than the inside diameter of the previous ring. The concentric ring pattern extends to cover a single sensor location—such as an array spot or a microtiter plate well. Each separate microarray spot or microtiter plate well has a separate concentric ring pattern centered within it. All polarization directions of such a structure have the same cross-sectional profile. The concentric ring structure must be illuminated precisely on-center to preserve polarization independence. The grating period of a concentric ring structure is less than the wavelength of the resonantly reflected light. The grating period is about 0.01 micron to about 1 micron. The grating depth is about 0.01 to about 1 micron.

In another embodiment, an array of holes or posts are arranged to closely approximate the concentric circle structure described above without requiring the illumination beam to be centered upon any particular location of the grid. Such an array pattern is automatically generated by the optical interference of three laser beams incident on a surface from three directions at equal angles. In this pattern, the holes (or posts) are centered upon the corners of an array of closely packed hexagons. The holes or posts also occur in the center of each hexagon. Such a hexagonal grid of holes or posts has three polarization directions that “see” the same cross-sectional profile. The hexagonal grid structure, therefore, provides equivalent resonant reflection spectra using light of any polarization angle. Thus, no polarizing filter is required to remove unwanted reflected signal components. The period of the holes or posts can be about 0.01 microns to about 1 micron and the depth or height can be about 0.01 microns to about 1 micron.

A detection system can comprise a colorimetric resonant reflectance biosensor a light source that directs light to the colorimetric resonant reflectance biosensor, and a detector that detects light reflected from the biosensor. In one embodiment, it is possible to simplify the readout instrumentation by the application of a filter so that only positive results over a determined threshold trigger a detection.

By measuring the shift in resonant wavelength at each distinct location of a colorimetric resonant reflectance biosensor of the invention, it is possible to determine which distinct locations have, e.g., biological material deposited on them. The extent of the shift can be used to determine, e.g., the amount of binding partners in a test sample and the chemical affinity between one or more specific binding substances and the binding partners of the test sample.

A colorimetric resonant reflectance biosensor can be illuminated twice. The first measurement determines the reflectance spectra of one or more distinct locations of a biosensor with, e.g., no biological material on the biosensor. The second measurement determines the reflectance spectra after, e.g., one or more cells are applied to a biosensor.

The difference in peak wavelength between these two measurements is a measurement of the presence or amount of cells on the biosensor. This method of illumination can control for small imperfections in a surface of a biosensor that can result in regions with slight variations in the peak resonant wavelength. This method can also control for varying concentrations or density of cell matter on a biosensor.

### Surface of Biosensor

One or more cells, adhesion proteins, extracellular matrix molecules, carbohydrate ligands (e.g., selectins), or integrin ligands can be immobilized on a biosensor by for example, physical adsorption or by chemical binding. A cell can specifically bind to a biosensor surface via a specific binding substance such as a nucleic acid, peptide, an antibody or binding fragment thereof that specifically binds an adhesion protein, protein solution, peptide solution, solutions containing compounds from a combinatorial chemical library, antigen, polyclonal antibody, monoclonal antibody, single chain antibody (scFv), F(ab) fragment, F(ab′)₂ fragment, Fv fragment, small organic molecule, virus, polymer or biological sample, wherein the specific binding substance is immobilized to the surface of the biosensor and the binding partner is on the surface of the cell.

Furthermore, cells, adhesion proteins, extracellular matrix molecules, carbohydrate ligands (e.g., selectins) or integrin ligands can be arranged in an array of one or more distinct locations on the biosensor surface, said surface residing within one or more wells of a multiwell plate and comprising one or more surfaces of the multiwell plate or microarray. The array of cells, adhesion proteins, extracellular matrix molecules, carbohydrate ligands (e.g., selectins), or integrin ligands comprises one or more cells, adhesion proteins, extracellular matrix molecules, carbohydrate ligands (e.g., selectins), or integrin ligands on the biosensor surface within a microwell plate such that a surface contains one or more distinct locations, each with a different cell, adhesion protein, extracellular matrix molecules, carbohydrate ligands (e.g., selectins), or integrin ligand or with a different amount of cells, adhesion proteins, extracellular matrix molecules, carbohydrate ligands (e.g., selectins), or integrin ligands. For example, an array can comprise 1, 10, 100, 1,000, 10,000 or 100,000 or greater distinct locations. Thus, each well of a multiwell plate or microarray can have within it an array of one or more distinct locations separate from the other wells of the multiwell plate, which allows multiple different samples to be processed on one multiwell plate. The array or arrays within any one well can be the same or different than the array or arrays found in any other microtiter wells of the same microtiter plate.

Immobilization of a cell, adhesion protein, extracellular matrix molecule, carbohydrate ligand (e.g., selectins), or integrin ligand to a biosensor surface can be also be affected via binding to, for example, the following functional linkers: a nickel group, an amine group, an aldehyde group, an acid group, an alkane group, an alkene group, an alkyne group, an aromatic group, an alcohol group, an ether group, a ketone group, an ester group, an amide group, an amino acid group, a nitro group, a nitrile group, a carbohydrate group, a thiol group, an organic phosphate group, a lipid group, a phospholipid group or a steroid group. Furthermore, a cell, adhesion protein, extracellular matrix molecule, carbohydrate ligand (e.g., selectins), or integrin ligand can be immobilized on the surface of a biosensor via physical adsorption, chemical binding, electrochemical binding, electrostatic binding, hydrophobic binding or hydrophilic binding, and immunocapture methods.

In one embodiment of the invention a biosensor can be coated with a linker such as, e.g., a nickel group, an amine group, an aldehyde group, an acid group, an alkane group, an alkene group, an alkyne group, an aromatic group, an alcohol group, an ether group, a ketone group, an ester group, an amide group, an amino acid group, a nitro group, a nitrile group, a carbohydrate group, a thiol group, an organic phosphate group, a lipid group, a phospholipid group or a steroid group. For example, an amine surface can be used to attach several types of linker molecules while an aldehyde surface can be used to bind proteins directly, without an additional linker. A nickel surface can be used to bind molecules that have an incorporated histidine (“his”) tag. Detection of “his-tagged” molecules with a nickel-activated surface is well known in the art (Whitesides, Anal. Chem. 68, 490, (1996)).

Linkers and specific binding substances can be immobilized on the surface of a biosensor such that each well has the same linkers and/or specific binding substances immobilized therein. Alternatively, each well can contain a different combination of linkers and/or specific binding substances.

A cell, adhesion protein, extracellular matrix molecule, carbohydrate ligand (e.g., selectins), or integrin ligand can specifically or non-specifically bind to a linker or specific binding substance immobilized on the surface of a biosensor. Alternatively, the surface of the biosensor can have no linker or specific binding substance and a cell, adhesion protein, extracellular matrix molecule, carbohydrate ligand (e.g., selectins), or integrin ligand can bind to the biosensor surface non-specifically.

Immobilization of one or more specific binding substances or linkers onto a biosensor is performed so that a specific binding substance or linker will not be washed away by rinsing procedures, and so that its binding to cells in a test sample is unimpeded by the biosensor surface. Several different types of surface chemistry strategies have been implemented for covalent attachment of specific binding substances to, for example, glass for use in various types of microarrays and biosensors. These same methods can be readily adapted to a biosensor of the invention. Surface preparation of a biosensor so that it contains the correct functional groups for binding one or more specific binding substances is an integral part of the biosensor manufacturing process.

One or more specific cells, adhesion proteins, extracellular matrix molecules, carbohydrate ligands (e.g., selectins), or integrin ligands can be immobilized to a biosensor surface by physical adsorption (i.e., without the use of chemical linkers) or by chemical binding (i.e., with the use of chemical linkers) as well as electrochemical binding, electrostatic binding, hydrophobic binding and hydrophilic binding. Chemical binding can generate stronger attachment of substances on a biosensor surface and provide defined orientation and conformation of the surface-bound molecules.

Immobilization of cells, adhesion proteins, extracellular matrix molecules, carbohydrate ligands (e.g., selectins), or integrin ligands to plastic, epoxy, or high refractive index material can be performed essentially as described for immobilization to glass. However, the acid wash step can be eliminated where such a treatment would damage the material to which the specific binding substances are immobilized.

### Detecting Changes in Cell Growth Patterns or Cell Properties

It has been estimated that at least 8-24 hours of laboratory time and the use of a secondary dye are required to quantify total cell movement or cell changes in response to biological entities, such as a protein, peptide or small molecule. See, Reckless & Grainger. 1999. Biochem. J. 340: 803-811, Taguchi et al. 1998. J. Exp. Med. 187(12): 1927-1940, Jackson et al. 1999. J. Pharm. & Exper. Therapeutics. 288(1): 286-294 and Yarrow et al., 2004 BMC Biotechnol. 4(21):1-9; see also, U.S. Patent Appl. 2003/0068657, U.S. Patent Appl. 2003/0108954, U.S. Patent Appl. 2004/0091397, U.S. Patent Appl. 2005/0221271, U.S. Patent Appl. 2005/0074825, U.S. Patent Appl. 2005/0058639, U.S. Pat. No. 7,018,838, U.S. Pat. No. 6,982,171, and U.S. Pat. No. 5,601,997. The required amount of time for these types of assays can be reduced to a maximum of 3 hours or less using methods and compositions of the invention. For example, depending on the length of time cells are allowed to incubate on the surface of the biosensor, an assay can be completed in less than about 3 hours, 2 hours, 1 hour, 45 minutes, 30 minutes, 20 minutes, 10 minutes, 5 minutes or 3 minutes. Additionally, no dyes or detection labels are necessary.

With embodiments of the instant invention cell motility and changes in cell properties can be detected as it occurs, thus circumventing the need to incorporate detection labels such as radiometric, colorimetric, fluorescent labels or the need to use microscopy for evaluation. A colorimetric resonant reflectance biosensor detects directional cell movement and cell attachment as the cells transverse from an area containing no chemoattractant or protein to an area possessing an entity that induces cell motility. Analysis of cellular movement across a biosensor surface can be expediently monitored in real time, in a label free manner. Several other changes in cell growth patterns or other cell changes can be detected using the methods of this invention, such as change in cell morphology, change in cell adhesion, change in cell migration, change in chemotaxis or other cell movement, change in cell proliferation, change in microtubule structure, change in microfilament structure, granule exocytosis, respiratory burst, cell differentiation (e.g., neuronal elongation), fluctuations in adherence, morphological rearrangement, cytoskeletal rearrangement, cellular differentiation, apoptosis and cell death, change in cell absorption properties, cell signaling (e.g., GPCR/chemokine, RTK, ion channel) and protein secretion. A change in cell properties includes anything that changes a cell's size, shape, height and/or surface uniformity. The methods of the invention can also be used to monitor the reaction and response of cells to environmental or chemical stimuli. Cell movement, changes in cell growth patterns, and other cell responses or changes can be detected in real time using the BIND® Biosensor, BIND® Reader, and BIND® Scanner (e.g., a colorimetric resonant reflectance biosensor system) and corresponding algorithms for quantification and analysis of data. See, e.g., U.S. Pat. No. 6,951,715, U.S. Patent Appl. Publ. 2004/0151626.

The BIND® Biosensor, BIND® Reader, and BIND® Scanner (e.g., a colorimetric resonant reflectance biosensor system) and corresponding algorithms can be used to obtain high resolution cell images without the use labels and without killing the cells. High resolution images on the scale of about 1, 2, 3, 4, 5, 6, 7, 8, 9, 10, 50, 75, 100, 150, 175, 200, 300 μm or less can be obtained. Previous methods have employed wide-area or low resolution methods that provide essentially a bi-modal readout that provides little detailed information about the cells' mechanism of response. In contrast, the methods of the invention can provide micrometer resolution, and highly detailed information about a single cell, clusters of cells, or confluent populations of cells and any response the cells may have to stimuli. Wide area or low resolution methods of observing cells can require 10,000 to 60,000 cells in a standard 384 cell culture plate well. The high resolution methods of the invention, however, can provide information on less than 10,000 cells in a standard 384 cell culture plate well. For example, less than about 10, 100, 500, 1,000, 2,500, 5,000, 7,500, or 10,000 cells can be monitored using the methods of the invention. In one embodiment, a single cell can be monitored.

The high resolution, label-free signal provides great detail about cells on the surface of the biosensor. A signal may fall because the an area is experiencing a general reduction, may fall because some of the area is experiencing no reduction but a majority of the area is experiencing reduction, or the majority of the area is experiencing a major reduction while a small area is actually increasing in signal. The present invention allows the area being studied to fall within a cell such that focal adhesion points, cell morphology and the like are being determined on the single cell level so that the specific reason that a signal is falling or rising can be determined. Methods of the invention can even determine the strength of the cells' attachment to the biosensor. Therefore, the methods of the invention can provide information on the responses/changes within the cell or cells and can provide information as to the size of the area in which the cell or cells respond.

Methods of the invention are advantageous because they do not require fixing and/or staining of cells for microscopic or colorimetric/fluorimetric evaluation, they allow for continuous, multiple independent readings of the same population of cells in real time, they are quick, they require minimal reagent usage (both volume and type), and they do not require flowing the cells through a counting device. Additionally, the direction and velocity of cell movement or path can be determined in real time.

Methods of the invention allow for continuous monitoring or multiple independent readings of the same population of cells in real time over many days. Cellular changes can be quantified expediently and objectively over longer periods of time in a normal culturing environment (static with proper media). Methods of the invention can also be used synergistically with fluorescent labels to obtain additional, intracellular data from each cell or cell population.

Cell motility and cell properties can be monitored by taking a PWV for one location over several time periods. Alternatively, scans of a receptacle holding the cells, e.g., a microtiter plate well, can be done over several time periods. A receptacle refers to one container and not a collection of containers, e.g., a multiwell plate.

One or more cells can be applied to a location, such as a microtiter well on a surface of a colorimetric resonant reflectance optical biosensor. In one embodiment of the invention, one or more cells or one or more types of cells can be immobilized to a surface of the biosensor by an antibody (or a binding fragment thereof) that specifically binds an adhesion protein such as integrins, selectins, members of the IgSuperfamily, cadherins, syndecans, and ADAMs. See, e.g., Buckley et al., 1998, Mol. Memb. Biol. 15:167. An adhesion protein is located on a cell surface and is important in binding reactions with other cells and the extracellular matrix. A colorimetric resonant reflectance optical peak wavelength value (PWV) for the location is detected. The one or more cells can be incubated for a period of time (e.g., about 1 second, 30 seconds, 1, 2, 5, 10, 20, 30, 45 minutes, 1, 2, 5, 10 or more hours). Prior to the incubation, or after the incubation, or prior to the incubation and after the incubation one or more test reagents can be applied to the one or more cells. The colorimetric resonant reflectance optical PWV for the location can be detected for a second time. If a change in cell growth pattern or cell property occurs then the reflected wavelength of light is shifted as compared to a situation where no change occurs. The first PWV can be compared to the second PWV. A change in the PWV can indicate a change in cell growth pattern or cell properties in the one or more cells. PWVs over several time periods can be determined and compared. PWVs can also be monitored in real time over the entire time of the assay. For example, PWVs can be taken every second or fractions of seconds over the entire time of the assay. PWVs can also be taken every 5 seconds, 10 seconds, 30 seconds, minute, 5 minutes, 10 minutes or every hour over the course of the assay.

“Specifically binds” or “specific for” means that a first antigen, e.g., a polypeptide, recognizes and binds to an antibody with greater affinity than to other, non-specific molecules. A non-specific molecule is an antigen that shares no common epitope with the first antigen. For example, an antibody raised against an antigen (e.g., a polypeptide) to which it binds more efficiently than to a non-specific antigen can be described as specifically binding to the antigen. In one embodiment an antibody or antigen-binding portion thereof specifically binds to a polypeptide when it binds with a binding affinity about Kₐ of 10⁷ l/mol or more. Specific binding can be tested using, for example, an enzyme-linked immunosorbant assay (ELISA), a radioimmunoassay (RIA), or a western blot assay using methodology well known in the art. Ligands and receptors can also specifically bind one another.

One or more antibodies (or binding fragments thereof) that specifically bind one or more adhesion proteins can be immobilized to the surface of the biosensor. One or more adhesion proteins can be added to the biosensor surface such that they are specifically bind to the immobilized antibodies. One or more types of cells are added to the surface of the biosensor before or after the addition of the adhesion proteins or at the same time the adhesion proteins are added to the biosensor surface. The cells can bind to the adhesion protein via a ligand that is specific for the adhesion protein. The adhesion protein can bind to the antibodies immobilized on the surface of the biosensor. Antibodies can directly bind adhesion proteins or antibodies can bind adhesion proteins through ligands fused or covalently or non-covalently bound to an adhesion protein. For example, the ZZ-binding domain of Protein A can be fused or bound to any adhesion protein. The adhesion protein can then bind IgG through the ZZ-binding domain of Protein A.

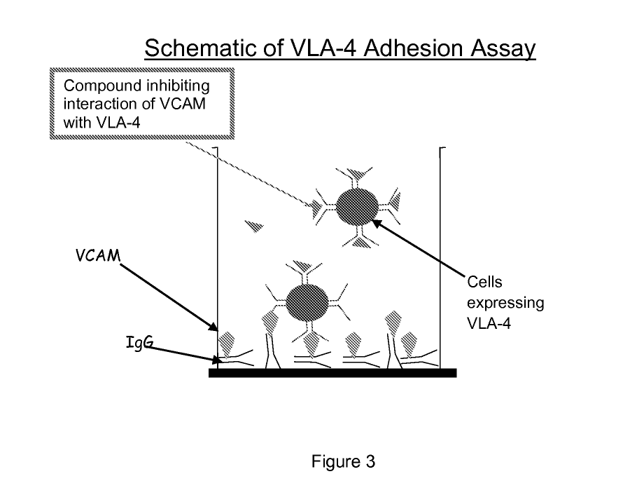

For example, VCAM-1 is an adhesion protein that is an endothelial ligand for VLA-4 and for integrin α4β7. VCAM-1 can be fused or bound to a ZZ-binding domain from Protein A. The ZZ-binding domain will specifically bind to IgG immobilized on the surface of the biosensor. Cells that express VLA-4 will bind to the VCAM-1 adhesion protein, which is bound to IgG immobilized to the surface of the biosensor. See FIG. 3. Therefore cells expressing an adhesion protein ligand will be immobilized to the biosensor surface.

Alternatively, one or more antibodies (or binding fragments thereof) that specifically bind one or more adhesion proteins can be immobilized to the surface of the biosensor. One or more types of cells that express the one or more adhesion proteins are added to the surface of the biosensor. The one or more adhesion proteins of the cells can bind to the immobilized one or more antibodies (or binding fragments thereof). Therefore, cells expressing adhesion proteins will be immobilized to the surface of the biosensor.

A test reagent can be, e.g., a metal ion such as Mn2+, Mg2+, or Ca2+, or a nucleic acid molecule, a polypeptide, an antigen, another cell type, an antibody fragment, a small organic molecule, or a small inorganic molecule. A small inorganic molecule or small organic molecule can be less than about 1, 5, 10, 50, 75, 100, 125, 150, 175, 200, 225, 250, 275 or 300 Da. Small organic or small inorganic molecules can be about 0.1 to about 500 Da, about 1 to about 300 Da, about 1 to about 200 Da, about 1 to about 100 Da, about 1 to about 50 Da, about 1 to about 25 Da, or any range in between about 0.1 to about 500 Da. A test reagent can also be a small molecule library, which can comprise about 5, 10, 25, 50, 100, 500, 1,000, 5,000, 10,000 or more different small molecules. Alternatively, a small molecule library can comprise only one type of small molecule. Cells can also be subjected to a change to a stimulus such as an environmental change (such as change in temperature, pressure or light).

Cells can respond to stimuli differently based upon what specific proteins or ligands the cell is bound. Therefore, the connections or binding events that the cell is actively involved in can affect how a cell will respond to stimuli such as test reagents or stimuli. The instant invention provides a method to simplify the connections or binding events the cell is experiencing during the assay. The only or one of the only binding events or connections the cell is making is between the cell receptor and adhesion protein that is bound to the one or more antibodies on the biosensor surface (or between a cell expressing an adhesion protein ligand and an adhesion protein that is bound to the one or more antibodies on the biosensor surface). Therefore, a more uniform response of the cell to stimuli or test reagents is expected.

Cell growth pattern or property changes at a biosensor location can be detected via the PWVs of the biosensor surface or monitored more generally using a microscope, digital camera, conventional camera, or other visualization apparatus, magnifying or non-magnifying, that utilizes lens-based optics or electronics-based charge coupled device (CCD) technology.

Preferably, the resolution of the lens of the scanner determining the PWV has an about 1, 2, 4, 5, 6, 7, 8, 9, 10, 11, 12, 13, 14, 15, 16, 17, 18, 19, or 20 micrometer pixel size. Previous scanners had a pixel size of greater than about 20 micrometers. Assays of the invention can be completed in less than 1, 2, 3, 4, 5, 6, 7, or 8 hours. That is, cell changes in response to, for example, and added reagent can be determined in a time efficient manner.

### Immune Cell Activation

Immune cells include, for example, lymphocytes such as B cells (e.g., plasma cells and memory cells), T cells (such as Tₕ cells and T_{c} cells), and natural killer cells. Immune cells also include, for example, granulocytes such as neutrophils, eosinophils, basophils, mast cells, monocytes, dendritic cells, and macrophages.

Methods of the invention can detect activation of an immune cell or a population of immune cells. Immune cells can be a homogenous population of immune cells (a population of immune cells that are all the same type of immune cells or a cloned population of one cell) or a heterogeneous population of immune cells (two or more types of immune cells or one or more types of immune cells with one or more types of non-immune cells).

Activation of lymphocytes is the clonal expansion and acquisition of functions directed at eliminating pathogens upon encountering a pathogen-specific antigen. Although the nature of the response is broad depending on the intruder, activation status of integrins to form the immunological synapse is an important measure of activation status of these immune cells.

Activation of B cells includes the induction of proliferation and differentiation into memory B cells and antibody secreting plasma cells through somatic hypermutation and class switching induced by helper T cells and cells of the innate immune system. The process is initiated by antigen binding to the B cell receptor (BCR) which leads to signaling through a kinase cascade, ultimately reorganizing the actin cytoskeleton and activating surface integrins inside-out. Measuring the activation of integrins can be an excellent indicator of B cell activation.

Activation of granulocytes is measurable by the activation of their surface integrins. These cells express, e.g., αMβ2 (Mac1), αLβ2 (LFA1), and α9β1 on their surfaces. These integrins can be activated by chemokines. Measuring activation of these integrins can be an excellent indicator of granulocyte activation.

Integrins mediate cell to cell and cell to extracellular matrix adhesion. Integrin activation can be used to determine/identify/measure/quantify activation of lymphocytes and granulocytes. Integrin activation is the increase in affinity of integrin receptors for their extracellular ligands. See, e.g., Calderwood, J. Cell Sci. 117:657-666 (2004). Intercellular signals act on integrin cytoplasmic domains and induce conformational changes in integrin extracellular domains that results in an increased affinity for the extracellular ligand. Id. Increased affinity indicating activation of integrins can be 1, 2, 3, 4, 5, 10, 20, 30, 40, 50, 60, 70, 80, 90, 100% or more affinity over non-activated integrins.

In the past, activation of integrins on the surfaces of B cells and T cells was measured by using state-specific integrin antibodies. Antibodies that recognize integrins were used in flow cytometry to determine the populations of activated leukocytes. Also, ICAM-1 or VCAM-1-coated beads were used to capture active leukocytes, which were then quantified using flow cytometry. For certain granulocytes, such as neutrophils, activation status was measured by peroxidase assays utilizing either fluorescence or chemiluminescence substrates. The instant invention does not require the use of integrin-specific antibodies, flow cytometry, or chemiluminescence. The instant methods can measure immune cell activation quickly and in a high throughput manner.

In the methods of the invention, one or more adhesion proteins are immobilized on the surface of a colorimetric resonance reflectance biosensor. Adhesion proteins are proteins located on the cell surface involved with the binding with other cells or with the extracellular matrix (ECM) in cell adhesion processes. Examples of adhesion proteins include, for example, Ig superfamily cell adhesion molecules, integrins, cadherins, and selectins. Integrins are heterodimers containing an α and a β subunit. The α subunits include CD49a, CD49b, CD49c, CD49d, CD49e, CD49f, ITGA7, ITGA8, ITGA9, ITGA9, ITGA10, ITGA11, CD11D, CD103, CD11a, CD11b, CD51, ITGAW, and CD11c. β subunits include CD29, CD18, CD61, CD104, ITGB5, ITGB6, and ITGB7. Cadherins include classical, desmosomal, protocadherins, and unconventional types. Selectins include P-selectins, L-selectins and E-selectins. Ig superfamily cell adhesion molecules include, for example, SynCAMs, NCAMs, ICAM-1, ICAM-2, VCAM-1, PECAM-1, L1, CHL1, MAG, Nectins and nectin-like molecules, CD2, CD48, the SIGLEC family (e.g. CD22, CD83), the CTX family (e.g. CTX, JAMs, BT-IgSF, CAR, VSIG, ESAM).

One or more immune cells are added to the surface of the biosensor. A potential activator of the immune cells is added to the surface of the biosensor. Activators of immune cells are molecules, compounds, or test reagents that can activate an immune cell. An activator can be, for example, IgM antibodies, single domains of the heavy chain variable region of IgM antibodies, single domains of the light chain variable region of IgM antibodies, single-chain variable fragments (scFv) of IgM antibodies, (scFv)₂ fragments of IgM antibodies, Fab fragments of IgM antibodies, Fab′ fragments of IgM antibodies, F(ab′)₂ fragments of IgM antibodies, diabodies of IgM and dsFv of IgM, multivalent IgM antibodies, or a combination thereof. In one embodiment of the invention an activator can be IgM, such as biotinylated IgM, optionally in the presence of neutravidin (e.g., multivalent IgM). An activator can also be a reagent that clusters B cell receptors or other cell receptors. An example is an antigen to an antibody displayed on the surface of a B cell as part of the B cell. Therefore, antigens specific for antibodies displayed on the surface of a B cell or other immune cells are also activators. An activator can be multivalent. Additionally, cytokines, e.g., such as CXCL-12 (also known as SDF1-α), are activators and can activate B cells and cause and adhesion of the B cells to an integrin ligand. Potential activators are test compounds or stimuli that have the potential to activate an immune cell.

The immune cells and potential activator can be added to the biosensor surface sequentially in any order or can be added to the biosensor surface at the same time.

If the immune cells or integrins of the cell are activated, then the cells will adhere to the immobilized adhesion proteins on the surface of the biosensor. Adhesion of the immune cells to the immobilized adhesion proteins is detected on the surface of the biosensor by illuminating the biosensor and detecting changes in peak wavelength values over time (e.g., two or more peak wavelength values can be determined at, for example, 1, 2, 3, 4, 5, 10, 15, 20, 30, 40, 45, 50, or 55, minutes, or 1, 2, 3, 4, 5, 6, 7, 8, 9, 10, 11, 12, 24, 36, 48, 60, 72 hours or more (or any range between about 1 minute and 72 hours)) after addition of all components to the biosensor surface. An increase in peak wavelength values over time indicates that the potential activator of the immune cells has activated the immune cells.

The activation of platelets includes exocytosis of dense and alpha granules, activation of phospholipase A2 leading to thromboxane A2 formation, change in cell shape forming finger-like protrusions, formation of a plug through the binding of von Willebrand Factor (vWF) to vWF receptor and glycoprotein IIb/IIIa to fibrinogen, promotion of coagulation and can be assessed by detecting the activation of their cell surface integrins. Specifically, the fibrinogen, vWF, fibronectin and vitronectin receptor α_{IIb}β₃ integrin is the major receptor that is required for platelet aggregation. Therefore, a similar adhesion assay to the immune cell activation assay can be conducted to assess the activation status of platelets.

One or more extracellular matrix molecules such as collagen, fibrinogen, elastin, fibrillin, laminin, proteoglycan, and fibronectin are immobilized on the surface of the biosensor. One or more types of platelets are added to the biosensor surface. A potential activator (e.g., thrombin or any other test reagent) of platelets is added to the biosensor surface. The platelets and potential activator can be added to the biosensor surface sequentially in any order or can be added to the biosensor surface at the same time.

If the platelets are activated, then they will adhere to the immobilized extracellular matrix molecules on the surface of the biosensor. Adhesion of the platelets to the immobilized extracellular matrix molecules is detected on the surface of the biosensor by illuminating the biosensor and detecting changes in peak wavelength values over time (e.g., two or more peak wavelength values can be determined at, for example, 1, 2, 3, 4, 5, 10, 15, 20, 30, 40, 45, 50, or 55, minutes, or 1, 2, 3, 4, 5, 6, 7, 8, 9, 10, 11, 12, 24, 36, 48, 60, 72 hours or more (or any range between about 1 minute and 72 hours)) after addition of all components to the biosensor surface. An increase in peak wavelength values over time indicates that the potential activator of the platelets has activated the platelets.

Additionally, the blocking or enhancing properties of a test molecule on the activation of one or more immune cells or platelets can be detected using the methods of the invention. One or more adhesion proteins or extracellular matrix molecules are immobilized on the surface of a colorimetric resonance reflectance biosensor. One or more types of immune cells or platelets are added to the biosensor, which become immobilized to the surface of the biosensor by binding to the one or more adhesion proteins or extracellular matrix molecules. An activator (described above) of the immune cells or platelets is added to the surface of the biosensor. A test reagent or stimuli (e.g., change in temperature, light, pressure, or pH) is added to the surface of the biosensor; wherein the one or more types of immune cells or platelets, activator, and test reagent or stimuli can be added to the biosensor surface sequentially (individually or in combination) in any order or at the same time.

Adhesion of the immune cells or platelets to the adhesion proteins or extracellular matrix molecules on the surface of the biosensor is detected by illuminating the biosensor and detecting changes in peak wavelength values over time (e.g., two or more peak wavelength values can be determined at, for example, 1, 2, 3, 4, 5, 10, 15, 20, 30, 40, 45, 50, or 55, minutes, or 1, 2, 3, 4, 5, 6, 7, 8, 9, 10, 11, 12, 24, 36, 48, 60, 72 hours or more (or any range between about 1 minute and 72 hours)) for each immune cell or platelet on the surface of the biosensor.

The changes in peak wavelength values for each immune cell or platelet are compared to a control reaction that does not comprise the test reagent or stimuli, wherein an increase in peak wavelength values over time as compared to the control reaction indicates that the test reagent or stimuli enhances immune cell or platelet activation, and wherein a decrease in peak wavelength values over time as compared to the control reaction indicates that the test reagent or stimuli blocks activation of the immune cells or platelets. The control data does not need to be generated at the same time as the data from the test cells or platelets. That is, the test data can be compared to historical control data. In one embodiment, an increase in peak wavelength value is 5, 10, 15, 20, 30, 40, 50, 60, 70, 80, 90, 100 percent or more over the control reactions indicates that the test reagent or stimuli enhances immune cell or platelet activation.

### Hybridoma Screening

The invention provides methods of selecting hybridomas producing antibodies to an antigen for quality of strength of binding to its relevant epitope. Identifying hybridomas with the strongest binding to their corresponding epitope is important because the stronger the antibody binding, the better the therapeutic utility. Better antibody binding means better inhibition and better specificity for the epitope. In the past screening for hybridomas having the strongest binding was accomplished using binding assays such as ELISA and surface plasmon resonance assays. These methods requires growing hybridoma cells and testing supernatant, which requires growing a large number of clones and screening all of them. The methods of the instant invention do not require these steps. In addition, conditions of the instant methods can be set to enrich for hybridomas producing high affinity antibodies. This can be done by optimizing the amount of antigen presented to the hybridomas as well as optimizing the adhesion ligand (e.g., ICAM-1) coated on the surface. Once these conditions are adjusted, the assay time can be set to allow for fastest and strongest adhering hybridoma cells to be captured on the biosensor, washing away the cells that did not attach at the time. These hybridomas are the ones expressing the highest affinity antibodies to the antigen of interest.

Hybridomas, even hybridomas specific for the same antigen or epitope, produce antibodies that vary in the strength to which they will bind to the antigen or epitope to which the hybridomas are specific. Methods of identifying the hybridomas in a mixed population of hybridomas that produce antibodies with the highest quality binding (i.e., the strongest binding in a population) is important. In one embodiment, the hybridomas produce an antibody having a high antigen affinity, e.g., a dissociation constant (Kd). Kd, indicates the strength of binding between the antibody and the antigen or epitope in terms of how easy it is to separate the antibody/antigen complex.

Where a high concentration of antibody and antigen or epitope is required to form the complex then the strength of binding is low. The Kd is therefore higher (mM rather than nM). Therefore, the smaller the Kd, the stronger the binding of the antibody to the antigen or epitope. A Kd of about 10⁻⁶M (or 1 mM) indicates weak binding as compared to the stronger binding of 10⁻⁹M (or 1 nM). In one embodiment of the invention an antibody with quality strength of binding has a Kd of about 10⁻⁸M, 10⁻⁹M, 10⁻¹⁰M, 10⁻¹¹M, 10⁻¹²M, 10⁻¹³M, 10⁻¹⁴M, 10⁻¹⁵M or any range between about 10⁻⁸M to about 10⁻¹⁵M.

One or more hybridomas, for example, 2, 3, 4, or 5 types of hybridomas or a large mixed population of hybridomas) are added to the surface of colorimetric resonance reflectance biosensor. The biosensor can have one or more integrin ligands immobilized to its surface. An integrin ligand is a molecule that binds to an integrin or a molecule that an integrin binds when the integrin is in an activated state. Integrin ligands include, for example, ICAM-1, ICAM-2, VCAM-1, collegen types I through XXIX, laminins (e.g. laminins made up of alpha-chains: LAMA1, LAMA2, LAMA3, LAMA4, LAMA5; beta-chains: LAMB1, LAMB2, LAMB3, LAMB4; and gamma-chains: LAMC1, LAMC2, LAMC3), fibronectin, proteinases, serum proteins, fibrinogen, vitronectin, osteopontin, Cyr61, and TGFβ1+3.

The integrin ligand can be immobilized to the surface of the biosensor. The antigen (e.g., a protein, a polypeptide, a polysaccharide, lipid, nucleic acid, or combination thereof) or epitope (the specific part of the antigen that is recognized by the immune system) to which the hybridomas are specific (e.g., soluble antigen preparations) is added to the surface of the biosensor. Hybridomas are specific for the antigen or epitope that was used to generate the hybridoma. A hybridoma can be made by, for example, injecting an antigen or epitope into an animal over the course of several weeks. Splenocytes are harvested from the animal and fused with immortalized myeloma cells. Fused cells are incubated in HAT medium. Cells are then usually plated individually into separate wells of a multi-well plate. The cells multiply in the individual wells and produce monoclonal antibodies specific for the same epitope. The instant invention does not require that the hybridomas be separated into individual wells, which is a major improvement compared to prior art methods of screening hybridomas.

The biosensor is illuminated and changes in peak wavelength value are over time are detected for each individual hybridoma on the surface of the biosensor. Hybridomas with the largest increases in peak wavelength value over time are selected and isolated. These hybridomas produce antibodies to the antigen with the greatest strength of binding to the antigen or epitope.

The selected, isolated hybridomas can be added individually to the surface of a colorimetric resonant reflectance biosensor (e.g., each isolated hybridoma is added to a well of a biosensor microtiter plate), wherein capture molecules for the antibodies produced by the hybridoma are immobilized on the biosensor surface (e.g., the antigen or epitope used to originally generate the hybridoma). The hybridoma is allowed to multiply into a hybridoma population. The biosensor is illuminated and changes in peak wavelength value are detected for each hybridoma population. Hybridoma populations having the greatest increase in peak wavelength value are selected. These hybridomas produce the greatest quantity of antibodies

### Human Antibody Screening

Antibody screening cannot currently be accomplished in a high throughput manner. Antibodies are screened in order to identify the best quality and quantity of antibodies produced by B cells. Every individual, in their repertoire of B cells, has clones of B cells that produce an antibody to any immunogen that individual has been exposed to. The methods of the invention can identify B cells producing the best antibodies (e.g., those with strongest binding to the relevant epitope and those producing the most antibodies) in a population of B cells. The cells can be isolated and grown to produce the antibody (either by immortalizing the B cells themselves or by making hybridomas).

The invention also provides methods for determining if a subject (e.g., an animal or a mammal, such as a human) has had an immune response to an immunogen. An immunogen is a substance that can provoke an adaptive immune response. The method comprises obtaining test B cells from a subject. The test B cells are added to the surface of a colorimetric resonance reflectance biosensor. The surface of the biosensor can be coated with an integrin ligand such as ICAM-1 or VCAM-1. The integrin ligand can be immobilized to the surface of the biosensor. The immunogen is added to the surface of the biosensor. The B cells and immunogen can be added to the biosensor surface sequentially in any order or at the same time. The biosensor is illuminated and changes in peak wavelength values are detected over time (e.g., two or more peak wavelength values can be determined at, for example, 1, 2, 3, 4, 5, 10, 15, 20, 30, 40, 45, 50, or 55, minutes, or 1, 2, 3, 4, 5, 6, 7, 8, 9, 10, 11, 12, 24, 36, 48, 60, 72 hours or more (or any range between about 1 minute and 72 hours)) for the test B cells. The changes in peak wavelength values for the test B cells are compared to a control B cell population that does not react with the immunogen or a test control reaction where the immunogen is not added to the B cells. An increase in peak wavelength values over time for the test B cells as compared to the control B cell population indicates that subject has had an immune response to the immunogen. The control B cell data does not need to be generated at the same time as the data from the test B cells. That is, the test B cell data can be compared to historical control B cell data. In one embodiment, an increase in peak wavelength value is 5, 10, 15, 20, 30, 40, 50, 60, 70, 80, 90, 100 percent or more over the control reactions indicates that the subject has had an immune response to the immunogen.

The invention also provides method of isolating neutralizing antibodies for an antigen, immunogen, or infectious organism. A neutralizing antibody is an antibody that can defend a cell from an antigen, immunogen, or infectious organism by inhibiting or neutralizing any effect of the antigen, immunogen, or infectious organism on the cell. These neutralizing antibodies can be used as therapeutic agents against, e.g., infectious organisms or cancer cells. These antibodies were made in the past by immunizing animals and making hybridomas, followed by humanizing these animal antibodies. Alternatively, various display technologies were used to identify these antibodies which were then expressed in a recombinant system. The methods of the invention can avoid these laborious and time consuming methods.

The methods of the invention comprise obtaining test B cells from a subject that has had an immune response to the antigen, immunogen, or infectious organism. For example, a subject that has been vaccinated with immunogen or has had a disease caused by the immunogen or a disease caused by an organism that comprises the immunogen. The test B cells are added to the surface of a colorimetric resonance reflectance biosensor in one or more test wells (i.e., one test population can be added to one well or each individual test B cell can each be added to an individual well). The surface of the biosensor can be coated with an integrin ligand such as ICAM-1 or VCAM-1. The integrin ligand can be immobilized to the surface of the biosensor. The immunogen, antigen or infectious organism is added to the surface of the biosensor. The test B cells and immunogen, antigen, or infectious organism can be added to the biosensor surface sequentially in any order or they can be added to the biosensor surface at the same time. The biosensor is illuminated and changes in peak wavelength values are detected over time for each test B cell. The changes in peak wavelength values for each test B cell are compared to a control B cell that does not react with the immunogen, antigen or infectious organism or to a control B cell that does not have the immunogen, antigen or infectious organism added to it. The test B cells having peak wavelength values higher than the control B cell are isolated. The control B cell data does not need to be generated at the same time as the data from the test B cells. That is, the test B cell data can be compared to historical control B cell data. In one embodiment, an increase in peak wavelength value is 5, 10, 15, 20, 30, 40, 50, 60, 70, 80, 90, 100 percent or more over the control reactions indicates that test B cells are producing a neutralizing antibody. Antibodies produced by the isolated test B cells are isolated. These isolated antibodies are neutralizing antibodies for the immunogen.

### Classification of B Cell Lymphomas

The invention provides methods for classifying B cell lymphomas. B cell lymphoma cells from patients show aberrant responses to cytokine activation that is revealed by the affinity of LFA-1 integrin to its ICAM-1 ligand. Sensitivity to inhibitors of small GTPases, Rho, Rac and CDC42 could further differentiate B cell lymphoma subtypes. The methods of the invention are well-suited to quantify adhesion. For example, B cells taken from patients can be stimulated with CXCL-12 and their LFA-1 affinity to ICAM-1 measured using our adhesion assay with or without specific inhibitors to downstream GTPases. Fleming, Y. M. et al. (2004) J. Cell Sci. 117: 2377-2388, Mammoto, A. et al. (2004) J. Biol. Chem. 279: 26323-26330, Desire, L., et al. 2005. J. Biol. Chem. 280, 37516, Pelish, H. E. et al. (2005) Nature Chemical Biol. 2, 39-46. Differential responses allow classification of the lymphomas (Cancer Res 2009; 69: (24). Dec. 15, 2009).

In one embodiment of the invention a B cell sample is obtained from a patient with an unclassified B cell lymphoma. The B cell sample is added to the surface of a colorimetric resonance reflectance biosensor having one or more adhesion proteins immobilized to the biosensor surface (e.g., ICAM-1 or VCAM-1). The B cells sample is activated by adding one or more chemokines to the cells. Chemokines include, for example, CXCL12, SDF-1, CKβ-11/MIP-3β/ELC, SLC/6Ckine/Exodus2, MIP-1β, BCA-1, BLC, CKβ, ELC, ENA-78, CCP-2, GRO, IP-10, LARC, LEC, LIX, LKN-1, MCIF, MCP, MDC, MIP, MPIF, NAP-2, PARC, PBSF, PR4, RANTES, SDF-1, SLC, TARC, TECK, CCR1, CCR2, CCR3, CCR4, CCR5, CCR6, CCR7, CCR8, CCR9, CXCR1, CXCR2, CXCR3, CXCR4, CXCR5, XCR1, CX₃CR1, TECK, CKβ-7/MIP-4, NCC-4/LEC/HCC-4, DC-CK1/PARC/MIP-4/AMAC-1 (CC chemokines), PF-4 (CXC chemokine). See, Kim, C. H. and Broxmeyer, H. E. (1999) Journal of Leukocyte Biology 65, 6-15.

Optionally, the B cell sample, the chemokine, and inhibitors of GTPases can be added to the biosensor surface sequentially in any order or they can be added to the biosensor surface at the same time. One or more specific inhibitors of GTPases can be added to the biosensor. The biosensor is illuminated and changes in peak wavelength values over time for each B cell sample can be detected. The responses of the B cell samples to known responses of B cell samples from patients with classified B cell lymphoma are compared such that the B cell lymphoma is classified. That is, the responses or the unclassified B cell sample over time is compared to the PWV signature over time of classified B cell lymphoma B cell samples. Where the responses match the B cell sample is classified. The known B cell lymphoma data does not need to be generated at the same time as the data from the test B lymphoma cells. That is, the test B cell lymphoma data can be compared to historical known B cell lymphoma data.

This methodology provides high-throughput capability of classifying B cell lymphomas, as well as a quantitative measure of integrin-mediated adhesion strength (which is not possible with any prior art methods). Strength of binding of B cells to adhesion proteins can be determined by measuring the increase in peak wavelength values over time and comparing to controls.

Controls that can be used in these experiments include, for example, B cell samples that are not treated with chemokines and/or inhibitors of GTPases and control adhesion protein coated biosensor surfaces.

### Antibody Display and Selection

The invention provides a method for selecting activated B-cells expressing an antibody to one or more specific antigens or epitopes to identify therapeutic antibodies. This allows for the identification of antibody producing cells rather than screening through their gene products and then expressing them recombinantly later. B-cells expressing antibody libraries on their cell surfaces are added to the surface of a biosensor having one or more integrin ligands such as ICAM-1 or VCAM-1 immobilized to its surface. The integrin ligand can be immobilized to the surface of the biosensor. The one or more specific antigens or epitopes are added to the surface of the colorimetric resonance reflectance biosensor. The amount of activation of each B-cell on the biosensor surface is determined by illuminating the biosensor and determining the changes in peak wavelength values over time (e.g., two or more peak wavelength values can be determined at, for example, 1, 2, 3, 4, 5, 10, 15, 20, 30, 40, 45, 50, or 55, minutes, or 1, 2, 3, 4, 5, 6, 7, 8, 9, 10, 11, 12, 24, 36, 48, 60, 72 hours or more (or any range between about 1 minute and 72 hours)) for each B cell, wherein an increase in peak wavelength values over time indicates B cell activation, and wherein a decrease or no change in peak wavelength values over time indicates no B cell activation. In one embodiment, an increase in peak wavelength value is 5, 10, 15, 20, 30, 40, 50, 60, 70, 80, 90, 100 percent or more over control reactions (e.g., reactions were antigens are known not to activate the B cells or where no antigen is added to the B cells) indicates that the B cells are activated. The control B cell data does not need to be generated at the same time as the data from the test B cells. That is, the test B cell data can be compared to historical control B cell data. Activated B cells are isolated. Activated B cells adhere to the biosensor surface coated with a integrin ligand (e.g., ICAM-1 for LFA1, VCAM-1 for VLA). At the peak activation time point (e.g., maximal activation), which usually occurs at about 1, 2, 3, 4, or 5 hours into the assay, the non-adherent (therefore inactive) B cells are aspirated and removed from the well. The remaining activated B cells produce antibodies to the presented antigen or epitope. Each B-cell can be isolated. The isolated B cell expresses an antibody to the one or more antigens or epitopes. The polynucleotide sequences corresponding to the expressed antibodies can be amplified and sequenced.

All patents, patent applications, and other scientific or technical writings referred to anywhere herein are incorporated by reference in their entirety. The invention illustratively described herein suitably can be practiced in the absence of any element or elements, limitation or limitations that are not specifically disclosed herein. Thus, for example, in each instance herein any of the terms “comprising”, “consisting essentially of”, and “consisting of may be replaced with either of the other two terms, while retaining their ordinary meanings. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by embodiments, optional features, modification and variation of the concepts herein disclosed may be resorted to by those skilled in the art, and that such modifications and variations are considered to be within the scope of this invention as defined by the description and the appended claims. In addition, where features or aspects of the invention are described in terms of Markush groups or other grouping of alternatives, those skilled in the art will recognize that the invention is also thereby described in terms of any individual member or subgroup of members of the Markush group or other group.

### EXAMPLES

### Example 1

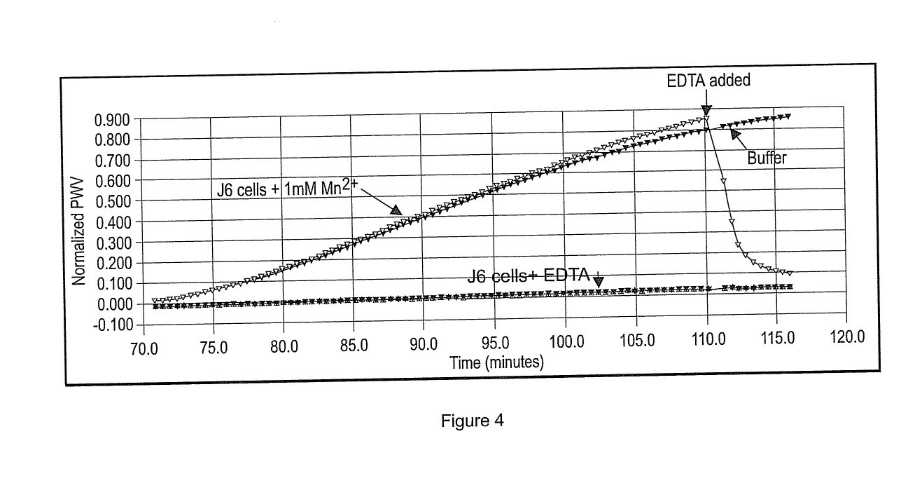

VCAM-1, which was fused to the ZZ-binding domain of Protein A, was added to a biosensor having IgG immobilized to its surface. J6 cells, which express VLA-4, were added to the biosensor surface. FIG. 4 shows normalized PWVs over time for J6 cells that were added to the biosensor. The “J6 cells+1 mM Mn²⁺” and “Buffer” lines shown in FIG. 4 both contained J6 cells and 1 mM Mn²⁺. The “J6 cells and EDTA” line contained J6 cells and EDTA. At the 110 minute mark, EDTA was added to the “J6 cells+1 mM Mn²⁺” cells. The amount of binding of cells to the VCAM-1 immobilized to the surface of the biosensor quickly dropped off because EDTA inhibits the ability of Mn²⁺to mediate VCAM-1 and VLA-4 binding. The results in FIG. 4 demonstrate that the PWV changes and therefore cell binding changes are indeed due to changes in VLA-4 and VCAM-1 binding.

### Example 2

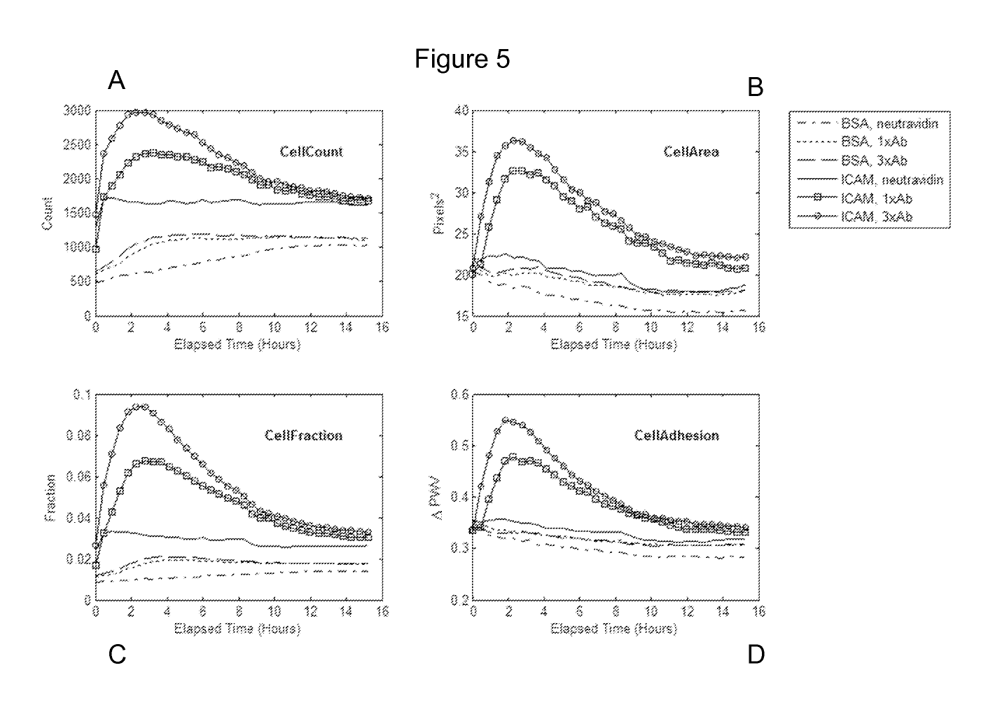

96 well TiO₂ colorimetric resonant reflectance biosensor plates with coated with ICAM-1 at a concentration of 1 μg at room temperature for 1 hour. The wells were blocked with 1% BSA at room temperature for 1 hour. Biotinylated goat anti-human IgM antibody F(ab)₂ fragments were incubated with neutravidin for 30 minutes to 1 hour at room temperature to form tetramers of antibody fragments. B cell lymphoma cell line RL from the ATCC was added to the wells at 40,000 cells per well in full growth medium on the ICAM-1 coated, BSA-blocked biosensor plates. B cell receptors were clustered and activated by adding the multimerized IgM antibody fragments. B cell activation was detected through LFA-mediated adhesion of B cells to the ICAM-1 coated biosensors using a BIND® scanner. The wells were scanned for 15 hours at room temperature at 3.75 resolution (sampling was done every 10 minutes). See FIG. 5A-D.

Wells with BSA, no ICAM-1, and no anti-IgM, and neutravidin showed no B cell binding. Wells with BSA only (that is no ICAM-1 and no neutravidin was added to the wells) and 1× anti-IgM (1× antibody was 10 μg/ml) showed no B cell binding. Wells with BSA only (that is no ICAM-1 and no neutravidin was added to the wells) and 3× anti-IgM showed no B cell binding. Wells with ICAM-1 and neutravidin showed no B cell binding

Wells with ICAM-1, 1× anti-IGM and no neutravidin showed no B cell binding. Wells with ICAM-1, 3× anti-IGM and no neutravidin showed no B cell binding. Wells with ICAM-1, anti-IgM (1× and 3×), and neutravidin showed strong B cell binding.

### Example 3

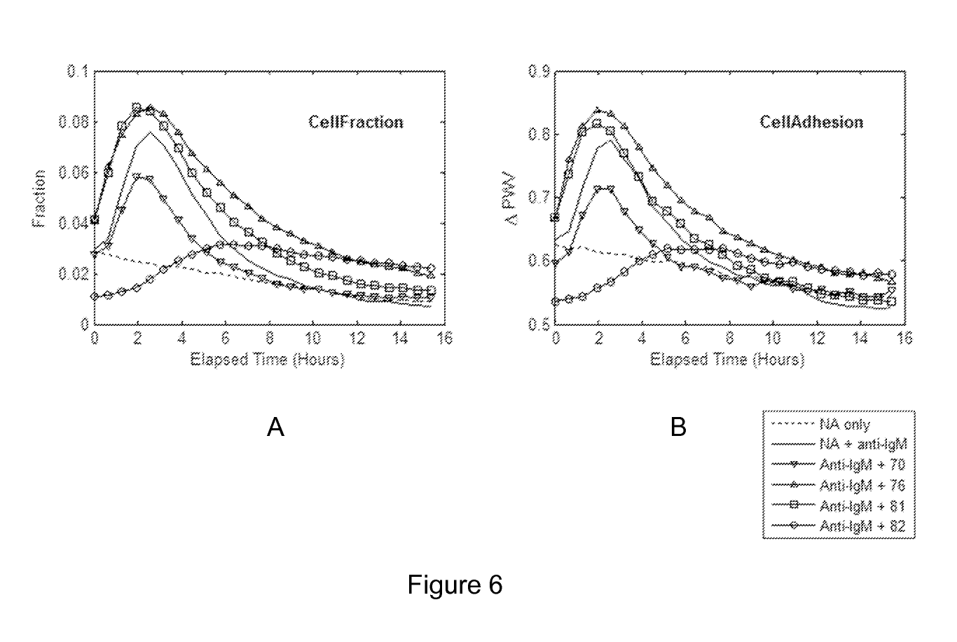

384 well TiO₂ colorimetric resonant reflectance biosensor plates were coated with ICAM-1 at a concentration of 1 μg at room temperature for 1 hour. The wells were blocked with 1% BSA at room temperature for 1 hour. Biotinylated goat anti-human IgM antibody F(ab)₂ fragments were incubated with neutravidin for 30 minutes to 1 hour at room temperature to form tetramers of antibody fragments. B cells were added to the wells on the ICAM-1 coated, BSA-blocked biosensor plates. B cell receptors were clustered and activated by adding the multimerized IgM antibody fragments. Four different test compounds named test compounds 70, 76, 81, and 82 were added to individual wells and B cell activation was detected through LFA-mediated adhesion of B cells to the ICAM-1 coated biosensors using a BIND® scanner. Test compounds 76 and 81 enhanced adhesion of the B cells to the VCAM-1 coated biosensors because greater adhesion was detected in the presence of these compounds than in the absence of these compounds. See FIG. 6A-B. Test compounds 70 and 82 blocked adhesion of the B cells to the VCAM-1 coated biosensors because less adhesion was detected in the presence of compounds 70 and 82 compound than in the absence of compounds 70 and 82. See FIG. 6A-B.

We claim:

1. A method for detecting activation of immune cells or platelets comprising:
(a) immobilizing one or more adhesion proteins or extracellular matrix molecules on the surface of a colorimetric resonance reflectance biosensor;
(b) adding one or more types of immune cells or platelets to the surface of the biosensor;
(c) adding a potential activator of the immune cells or the platelets to the surface of the biosensor;
(d) detecting adhesion of the immune cells to the adhesion proteins or the adhesion of the platelets to the extracellular matrix molecules on the surface of the biosensor by illuminating the biosensor and detecting changes in peak wavelength values over time; wherein an increase in peak wavelength values over time indicates that the potential activator of the immune cells has activated the immune cells or that the potential activator of the platelets has activated the platelets.

2. The method of claim 1, wherein the immune cells are lymphocytes or granulocytes.

3. The method of claim 1, wherein the adhesion protein is ICAM-1 or VCAM-1.

4. A method for detecting blocking or enhancing properties of a test reagent or stimuli on activation of one or more immune cells or platelets comprising:
(a) immobilizing one or more adhesion proteins or extracellular matrix molecules on the surface of a colorimetric resonance reflectance biosensor;
(b) adding one or more types of immune cells or platelets to the surface of the biosensor;
(c) adding an activator of the immune cells or platelets to the surface of the biosensor;
(d) adding a test reagent or stimuli to the surface of the biosensor; wherein the one or more types of immune cells, platelets, activator, and test reagent or stimuli can be added to the biosensor surface sequentially in any order, or at the same time;
(e) detecting adhesion of the immune cells to the adhesion proteins or adhesion of the platelets to the extracellular matrix molecules on the surface of the biosensor by illuminating the biosensor and detecting changes in peak wavelength values over time for each immune cell or platelet;
(f) comparing the changes in peak wavelength values for each immune cell or platelet to a control that does not comprise the test reagent or stimuli, wherein an increase in peak wavelength values over time indicates that the test reagent or stimuli enhances immune cell or platelet activation, and wherein a decrease in peak wavelength values over time indicates that the test reagent or stimuli blocks activation of the immune cells.

5. The method of claim 4, wherein the adhesion protein is ICAM-1 or VCAM-1.

6. A method of selecting hybridomas producing antibodies to an antigen for highest strength of binding to the antigen comprising:
(a) adding one or more hybridomas to the surface of colorimetric resonance reflectance biosensor having one or more integrin ligands immobilized to the biosensor surface;
(b) adding the antigen to which the hybridomas are specific to the surface of the biosensor;
(c) illuminating the biosensor and detecting changes in peak wavelength value over time for each hybridoma; and
(d) selecting and isolating the hybridomas with the largest increases in peak wavelength value over time;
wherein hybridomas are selected that produce antibodies to the antigen with the highest strength of binding to the antigen.

7. The method of claim 6, further comprising:
(e) adding the individual selected hybridomas to a colorimetric resonant reflectance biosensor, wherein capture molecules for the antibodies produced by the hybridoma are immobilized on the biosensor surface and allowing the hybridoma to multiply to form a hybridoma population;
(f) illuminating the biosensor and detecting changes in peak wavelength value for each hybridoma;
(g) selecting hybridomas having the greatest increase in peak wavelength value;
whereby hybridomas are selected that produce the greatest quantity of antibodies.

8. The method of claim 6, wherein the one or more integrin ligands are VCAM-1 or ICAM-1.

9. A method of determining if a subject has had an immune response to an immunogen comprising:
(a) obtaining test B cells from a subject;
(b) adding the test B cells to the surface of a colorimetric resonance reflectance biosensor having one or more integrin ligands immobilized to the biosensor surface;
(c) adding the immunogen to the surface of the biosensor;
(d) illuminating the biosensor and detecting changes in peak wavelength values over time for the test B cells; and
(e) comparing the changes in peak wavelength values for the test B cells to a control B cell population that does not react with the immunogen;
wherein an increase in peak wavelength values over time for the test B cells as compared to the control B cells indicates that the subject has had an immune response to the immunogen.

10. The method of claim 9, wherein the one or more integrin ligands are VCAM-1 or ICAM-1.

11. A method of isolating neutralizing antibodies for an immunogen comprising:
(a) obtaining test B cells from a subject that has had an immune response to the immunogen;
(b) adding the test B cells to the surface of a colorimetric resonance reflectance biosensor having one or more integrin ligands immobilized to the biosensor surface;
(c) adding the immunogen to the surface of the biosensor;
(d) illuminating the biosensor and detecting changes in peak wavelength values over time for each test B cell;
(e) comparing the changes in peak wavelength values for each test B cell to a control B cell that does not react with the immunogen or that is not exposed to the immunogen;
(f) isolating the test B cells having peak wavelength values higher than the control B cell; and
(g) isolating antibodies produced by the isolated test B cells;
wherein neutralizing antibodies for the immunogen are isolated.

12. The method of claim 11, wherein the one or more integrin ligands are VCAM-1 or ICAM-1.

13. A method of classifying a B cell lymphoma comprising:
(a) obtaining a B cell sample from a patient with an unclassified B cell lymphoma;
(b) adding the B cell sample to the surface of a colorimetric resonance reflectance biosensor having one or more adhesion proteins immobilized to the biosensor surface;
(c) adding one or more chemokines to the biosensor;
(c) optionally adding one or more specific inhibitors of GTPases to the biosensor;
(d) illuminating the biosensor and detecting changes in peak wavelength values over time for each B cell sample; and
(e) comparing the responses of the B cell samples to known responses of B cell samples from patients with classified B cell lymphoma,
wherein the B cell lymphoma is classified.

14. The method of claim 13, wherein the one or more adhesion proteins are VCAM-1 or ICAM-1.

15. A method for selecting activated B-cells expressing an antibody to one or more antigens comprising:
(a) adding B-cells expressing antibody libraries on their cell surfaces to the surface of a colorimetric resonance reflectance biosensor having one or more integrin ligands immobilized to the biosensor surface;
(b) adding the one or more antigens to the surface of the colorimetric resonance reflectance biosensor;
(c) determining the amount of activation of each B-cell on the biosensor surface by illuminating the biosensor and determining the changes in peak wavelength values over time for each B cell, wherein an increase in peak wavelength values over time indicates B cell activation, and wherein a decrease or no change in peak wavelength values over time indicates no B cell activation; and
(d) isolating activated B cells;
wherein a B-cell that expresses an antibody to the one or more antigens is selected.

16. The method of claim 15, wherein polynucleotide sequences corresponding to the expressed antibodies are amplified.

17. The method of claim 15, wherein the one or more integrin ligands are VCAM-1 or ICAM-1.
